(19) United States
(12) Patent Application Publication
(10) Pub. No.: US 2024/0376973 A1
(43) Pub. Date: Nov. 14, 2024

(54) DIFFERENTIAL ASSEMBLY

(71) Applicant: M/S DRB DIFF SPARES & AXLES PTY LTD, Dandenong (AU)

(72) Inventor: Shashi Kant Sharma, Danednong (AU)

(21) Appl. No.: 18/401,393

(22) Filed: Dec. 30, 2023

(30) Foreign Application Priority Data
May 11, 2023 (IN) 202311033414

(51) Int. Cl. F16H 57/00; F16H 48/08; F16H 48/22; F16H 48/40; F16H 57/04

(52) U.S. Cl. CPC F16H 57/0006; F16H 48/08; F16H 48/22; F16H 48/40; F16H 57/0427; F16H 57/0483; F16H 2048/387

(57) ABSTRACT

The present disclosure provides a differential assembly100. The differential assembly100 includes a differential case102, a plurality of gears104, and an elastic element106. The plurality of gears104 is arranged inside the differential case 102. The elastic element106 is disposed between the differential case102 and the plurality of gears104. The elastic element106 further comprises an inner conferential surface204, an outer circumferential surface202, a plurality of mounting holes302, a plurality of apertures206, a plurality of discs208, and a plurality of lubrication arrangements. The plurality of lubrication arrangements provided at a circumferential direction of the inner204 and the outer circumferential surface202 of the elastic element106 for flowing a lubricant inside the differential case102, the plurality of discs208, and the plurality of gears104. Further, the elastic element106 is a disc washer, and the plurality of lubrication arrangement includes a plurality of oil holes402, a plurality of oil cut-outs404, and a plurality of oil grooves406.

### TECHNICAL FIELD

The present invention relates to the field of a limited slip differential and, more particularly to a differential assembly for improving the functionality and locking response of the differential assembly and maintain zero tolerance to avoid backlash in the plurality of gears.

### BACKGROUND

A differential for a vehicle is a mechanism that enables left and right (or front and rear) drive wheels to rotate at different rotational speeds. A differential assembly comprises a left half-shaft gear, a right half-shaft gear, two planet gears, and a gear carrier. When the automobile turns or runs on an uneven road surface, the left wheel and the right wheel roll at different rotating speeds, and the pure rolling motion of the driving wheels at two sides is ensured. The differential is used for adjusting the difference in the rotational speeds of the left and right wheels of the vehicle.

Conventionally, the differential assembly exhibits limited-slip differential function with improved wear resistance by suppressing deviation or inclination of a pinion gear, a plurality of pinion gears is held in an internal space of carrier along a circumferential direction of a concentric rotation axis. Further, a washer is arranged between the first sidewall portion and the sun gear.

The pinion gear has a first convex portion and a second convex portion at both axial ends, and the washer is fitted with the first convex portion, and the pinion gear rotates and revolves relative to the washer. But, these washer fails in providing zero tolerance. This type of washer maximum provides 0.05 to 0.15 tolerance and also fails in removing clucking noise generated from changing the gears.

For example, J.P. Patent 2010223335 discloses a differential gear device that has a limited-slip differential function with improved wear resistance by suppressing deviation or inclination of a pinion gear. The differential gear device includes a sun gear, a ring gear, a pinion gear P, a carrier CA, and a thrust washer for holding the pinion gear P. The pinion gear P includes a first projection part and a second projection part at both ends in the axial direction.

Another example, J.P. Patent JP2003254415 A discloses a clutch type limited slip differential for preventing the seizure of a clutch surely. This clutch-type limited slip differential includes a clutch that is installed between the outer circumference of a back shaft of a side gear and the inner circumference of a differential cover and transmits power between the back shaft of the side gear and the differential cover by connecting it interruptedly.

However, nowhere in these references does it explicitly state about a plurality of gear design and an elastic element (i.e., a disc washer) that eliminates backlash/slack between a plurality of gears and maintains zero tolerance.

In none of the conventional mechanisms and assembly, there is any specification of a plurality of lubrication arrangements that allow a sufficient amount of a lubricant to pass through a differential case, a plurality of discs, and the plurality of gears.

In light of the above-stated discussion, there is a need for a novel differential assembly that is an enhancement to the conventional assembly and mechanism. The present invention is designed for maintaining zero tolerance by removing clucking noise generated from the differential assembly when changing a plurality of gears in a manual vehicle, and when setting the transmission to a reverse or a drive state in an automatic vehicle.

### Object of the Disclosure

A principal object of the present invention is to overcome the disadvantage of the prior art.

Another objective of the present disclosure is to provide a differential assembly for improving the functionality and locking response of the differential assembly.

Another objective is to provide the differential assembly for maintaining zero tolerance by removing clucking noise generated from the differential assembly when changing a plurality of gears in a manual vehicle, and when setting the transmission to a reverse or a drive state in an automatic vehicle.

Another objective is to provide the differential assembly that has a plurality of lubrication arrangements that allow a sufficient amount of a lubricant to pass through a differential case, the plurality of discs, and the plurality of gears.

Another objective is to provide the differential assembly that provides a plurality of apertures formed at an inner circumferential surface for attaching the plurality of gears.

Another objective is to provide the differential assembly that provides the plurality of gears while minimizing any potential backlash or slack.

Another objective is to provide the differential assembly that ensures a limited slip differential (LSD) mechanism may function optimally and reliably, even under extreme conditions.

Yet another objective of the present invention is to provide the differential assembly that is easy to assemble, economical, and cost-effective.

### SUMMARY OF THE DISCLOSURE

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

An embodiment of the present invention relates to a differential assembly. The differential assembly includes a differential case, a plurality of gears, and an elastic element.

In accordance with an embodiment of the present invention, the plurality of gears are arranged inside the differential case. Further, the elastic element is disposed between the differential case and the plurality of gears. Further, the elastic element may also be arranged between the plurality of gears.

In accordance with an embodiment of the present invention, the elastic element is a disc washer. The disc washer is a spring washer for providing a spring force and absorbs shock by providing an axial load that counters vibrations generated by the plurality of gears. Further, the elastic element is made of any one of a stainless steel, a carbon steel, an alloy steel, and a rubber.

In accordance with an embodiment of the present invention, the plurality of gears is any one or a combination of a sun gear, a ring gear, a helical gear, a pinion gear, a half axle gear, a planetary bevel gear, a bevel gear, among others.

In accordance with an embodiment of the present invention, the plurality of gears may vary from vehicle to vehicle depending on a size and a shape of the differential assembly.

In accordance with an embodiment of the present invention, the elastic element further comprises an inner conferential surface, an outer circumferential surface, a plurality of mounting holes, a plurality of apertures, a plurality of discs, and a plurality of lubrication arrangements.

In accordance with an embodiment of the present invention, the plurality of mounting holes formed at the outer circumferential surface for fastening the elastic element via a plurality of bolts.

In accordance with an embodiment of the present invention, the plurality of bolts are anyone of an anchor bolt, a carriage bolt, an eye bolt, a hex bolt, or a square head bolt.

In accordance with an embodiment of the present invention, the plurality of apertures formed at the inner circumferential surface for attaching the plurality of gears. The at least one disc from the plurality of discs, positioned between each of the plurality of gears.

In accordance with an embodiment of the present invention, a design of the plurality of discs allows the placement of a number of the plurality of gears according to the specific application. Further, the number of plurality of gears are anyone of at least four gears, at least five gears, at least six gears, at least seven gears, at least eight gears, at least nine gears, among others.

In accordance with an embodiment of the present invention, the plurality of lubrication arrangements provided at a circumferential direction of the inner and outer circumferential surface of the elastic elements for flowing a lubricant inside the differential case, the plurality of discs, and the plurality of gears.

In accordance with an embodiment of the present invention, the plurality of lubrication arrangement includes a plurality of oil holes, a plurality of oil cut-outs, and a plurality of oil grooves. Further, a shape of the plurality of oil holes, the plurality of cut-outs, and the plurality of oil grooves is a circular, a semi-circular, and a rectangular in nature respectively.

In accordance with an embodiment of the present invention, the plurality of oil holes are provided at a top surface of the elastic element. The plurality of oil cut-outs are provided at an outer periphery, and the plurality of oil grooves are provided at an inner periphery of an internal surface of the elastic element which is further attached with the plurality of oil cut-outs.

In accordance with an embodiment of the present invention, the differential assembly has a limited-slip differential (LSD) mechanism for limiting the differential rotation between the plurality of gears to distribute the rotational driving force to a driving wheel. Further, the limited-slip differential mechanisms are divided into multiple types, including but not limited to a mechanical friction type, and a rotational-speed-sensitive type.

In accordance with an embodiment of the present invention, the differential assembly further includes at least two pressure plates placed between the plurality of gears for applying a spring pressure in an outward direction to keep the plurality of gears engaged and limit the slack between the plurality of gears.

These and other aspects herein will be better appreciated and understood when considered in conjunction with the following description and the accompanying drawing. The foregoing objectives are attained by employing the differential assembly to improve the functionality and locking response of the differential assembly and maintain zero tolerance to avoid backlash in the plurality of gears.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure.

FIG. 1 is a cross-sectional view of a differential assembly 100 in accordance with an embodiment of the invention;

FIG. 2 is a perspective view of an elastic element 106 in accordance with an embodiment of the invention;

FIG. 3 is a line diagram of the elastic element 106 in accordance with an embodiment of the invention;

FIGS. 4A, 4B, & 4C illustrate a top view, a bottom view, and an internal view of the elastic element 106 respectively, in accordance with an exemplary embodiment of the invention; and

FIGS. 5A, 5B, & 5C illustrate a front view, an exploded view, and a combined view of a pressure plate arrangement in the differential assembly 100 respectively, in accordance with an exemplary embodiment of the invention.

It should be noted that the accompanying figure is intended to present illustrations of a few examples of the present disclosure. The figure is not intended to limit the scope of the present disclosure. It should also be noted that the accompanying figure is not necessarily drawn to scale.

### DETAILED DESCRIPTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively, and any and all combinations of any or more of such steps or features.

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably. The accompanying drawing is used to help easily understand various technical features and it should be understood that the alternatives presented herein are not limited by the accompanying drawing. As such, the present disclosure should be construed to extend to any alterations, equivalents and substitutes in addition to those which are particularly set out in the accompanying drawing. Although the terms first, second, etc. may be used herein to describe various elements, these elements should not be limited by these terms. These terms are generally only used to distinguish one element from another.

Conditional language used herein, such as, among others. “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

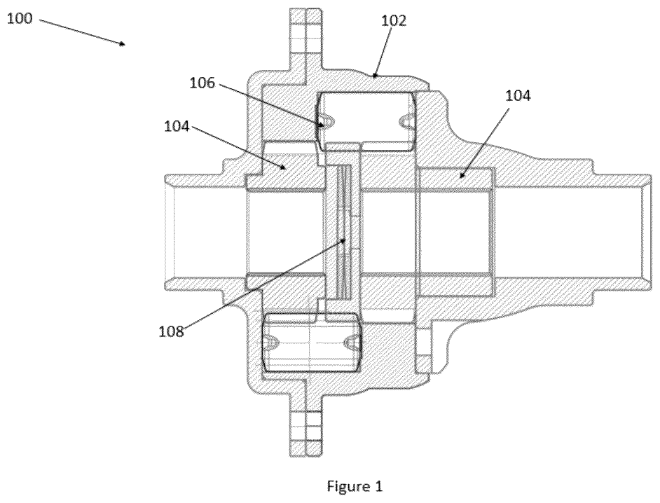

FIG. 1 is a cross-sectional view of a differential assembly 100 in accordance with an embodiment of the invention. Referring to FIG. 1, the differential assembly 100 includes a differential case 102, a plurality of gears 104, and an elastic element 106. The differential case 102 supports at its opposite axial ends by a plurality of bearing assemblies for rotation of a plurality of wheels. The differential case 102 is formed to include an enlarged interior chamber within which a gearset is retained.

In accordance with an embodiment of the present invention, at least two pressure plates 108 are placed between the plurality of gears 104. Further, the plurality of gears 104 are arranged inside the differential case 102. Further, the elastic element 106 is disposed between the differential case 102 and the plurality of gears 104. Further, the elastic element 106 may also be arranged between the plurality of gears 104.

In accordance with an embodiment of the present invention, the elastic element 106 is a disc washer. The disc washer is a spring washer for providing a spring force and absorbs shock by providing an axial load that counters vibrations generated by the plurality of gears 104. Further, the elastic element 106 is made of any one of a stainless steel, a carbon steel, an alloy steel, and a rubber.

In accordance with an embodiment of the present invention, the plurality of gears 104 is any one or a combination of a sun gear, a ring gear, a helical gear, a pinion gear, a half axle gear, a planetary bevel gear, a bevel gear, among others.

In accordance with an embodiment of the present invention, the plurality of gears 104 may vary from vehicle to vehicle depending on a size and a shape of the differential assembly 100.

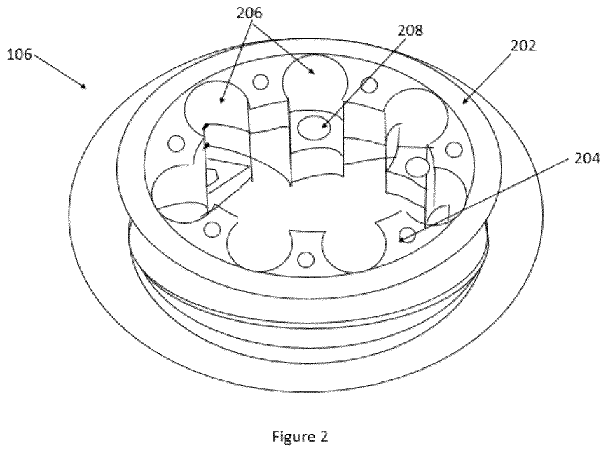

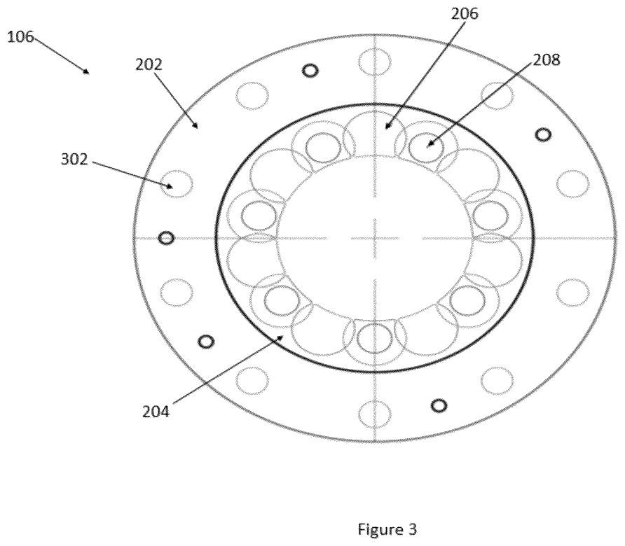

FIG. 2 is a perspective view of the elastic element 106 in accordance with an embodiment of the invention and FIG. 3 is a line diagram of the elastic element 106 in accordance with an embodiment of the invention.

In accordance with an embodiment of the present invention, the elastic element 106 further comprises an inner circumferential surface 204, an outer circumferential surface 202, a plurality of mounting holes 302 (refer FIG. 3), a plurality of apertures 206, a plurality of discs 208, and a plurality of lubrication arrangements.

In accordance with an embodiment of the present invention, the plurality of mounting holes 302 are formed at the outer circumferential surface 202 for fastening the elastic element 106 via a plurality of bolts. Further, the plurality of apertures 206 are formed at the inner circumferential surface 204 for attaching the plurality of gears 104. The at least one disc 208 from the plurality of discs 208 are positioned between each of the plurality of gears 104.

In accordance with an embodiment of the present invention, a design of the plurality of discs 208 allows the placement of a number of the plurality of gears 104 according to the specific application. Further, the number of plurality of gears 104 are anyone of at least four gears, at least five gears, at least six gears, at least seven gears, at least eight gears, at least nine gears, among others.

In accordance with an exemplary embodiment of the present invention, the at least seven apertures from the plurality of apertures 206 are formed at the inner circumferential surface 204 for attaching at least seven gears 104 from the plurality of gears 104. The at least one disc 208 from the plurality of discs 208 are positioned between each of the at least seven gears 104 to minimize any potential backlash or slack.

In accordance with an embodiment of the present invention, the plurality of lubrication arrangements provided at a circumferential direction of the inner 204 and outer circumferential surface 202 of the elastic element 106 for flowing a lubricant inside the differential case 102, the plurality of discs 208, and the plurality of gears 104.

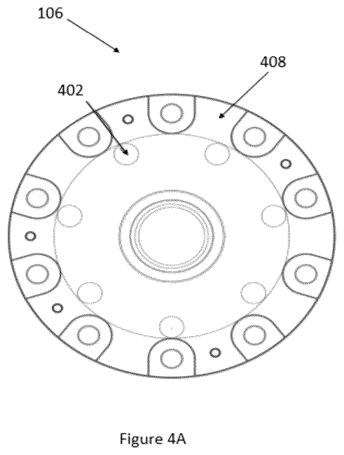

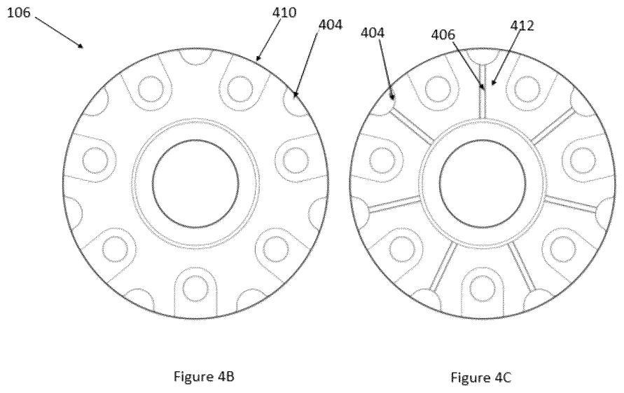

In accordance with an embodiment of the present invention, the plurality of lubrication arrangement includes a plurality of oil holes 402 (refer FIG. 4, exemplary embodiment), a plurality of oil cut-outs 404, and a plurality of oil grooves 406. Further, a number of the plurality of oil holes 402, the plurality of oil cut-outs 404, and the plurality of oil grooves 406 depend upon the number of the plurality of gears 104.

In accordance with an embodiment of the present invention, a shape of the plurality of oil holes 402, the plurality of oil cut-outs 404, and the plurality of oil grooves 406 is a circular, a semi-circular, and a rectangular in nature respectively.

In accordance with an embodiment of the present invention, the plurality of oil holes 402 are provided at a top surface 408 of the elastic element 106. The plurality of oil cut-outs 404 are provided at an outer periphery 410, and the plurality of oil grooves 406 are provided at an inner periphery 412 of an internal surface of the elastic element 106 which is further attached with the plurality of oil cut-outs 404.

In accordance with an embodiment of the present invention, the differential assembly 100 has a limited-slip differential (LSD) mechanism for limiting the differential rotation between the plurality of gears 104 to distribute the rotational driving force to a driving wheel. Further, the limited-slip differential mechanisms are divided into multiple types, including but not limited to a mechanical friction type, and a rotational-speed-sensitive type.

FIGS. 4A, 4B, & 4C illustrate a top view, a bottom view, and an internal view of the elastic element 106 respectively, in accordance with an exemplary embodiment of the invention.

In accordance with an embodiment of the present invention, the plurality of lubrication arrangement includes at least seven oil holes 402, at least seven oil cut-outs 404, and at least seven oil grooves 406. Further, a shape of the at least seven oil holes 402, the at least seven oil cut-outs 404, and the at least seven oil grooves 406 is same as the plurality of oil holes 402, the plurality of oil cut-outs 404, and the plurality of oil grooves 406 respectively.

In accordance with an embodiment of the present invention, the at least seven oil holes 402 are provided at the top surface 408 of the elastic element 106. The at least seven oil cut-outs 404 are provided at the outer periphery 410, and at least seven oil grooves 406 are provided at the inner periphery 412 of the internal surface of the elastic element 106 which is further attached with the at least seven oil cut-outs 404.

In accordance with an advantageous embodiment of the above exemplary embodiment, the top surface 408 of the elastic element 106 has the at least seven oil holes 402 that allow oil to pass through the differential case 102 and lubricate the plurality of discs 208. Without sufficient lubrication, the plurality of discs 208 may wear out quickly, leading to a loss of performance and potential damage to the differential assembly 100. In addition, the at least seven oil grooves 406 are provided at the inner periphery 412 of the elastic element 106 that has specific patterned oil grooves 406 that are designed to distribute the oil evenly throughout the differential case 102. These at least seven grooves 406 are important because they help to prevent hot spots of oils on the plurality of discs 208 at the time of distributing lubricants over the area of the plurality of discs 208, which might lead to the increase the overall performance of the differential assembly 100.

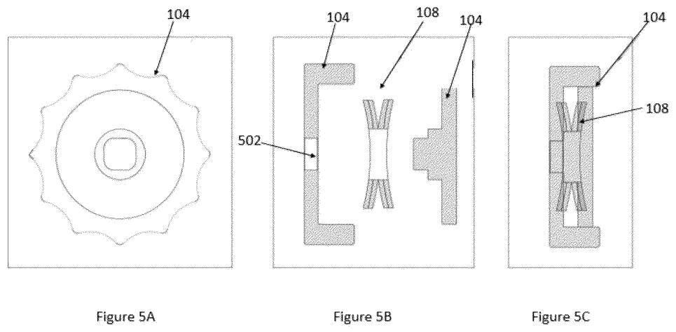

FIGS. 5A, 5B, & 5C illustrate a front view, an exploded view, and a combined view of a pressure plate arrangement in the differential assembly 100 respectively, in accordance with another exemplary embodiment of the invention.

In accordance with an embodiment of the present invention, the at least two pressure plates 108 are placed between the plurality of gears 104 for applying a spring pressure in an outward direction to keep the plurality of gears 104 engaged and limit the slack between the plurality of gears 104.

In accordance with an embodiment of the present invention, a gap 502 is provided in both side of the gears 104 from the plurality of gears 104 for placing the at least two pressure plates 108, as shown in FIG. 5 (B). The at least two pressure plates 108 are used to improve the performance & functionality of the differential assembly 100 and the plurality of gears 104.

In accordance with an embodiment of the present invention, the at least two pressure plates 108 work like a spring, and they are placed between the sun gears which apply the spring pressure for engaging the plurality of gears 104. The at least two pressure plates 108 are combined to make sure that the spring rotates at the same speed on which the vehicle's wheel are rotating. Since the plurality of wheels are moving at the same speeds then it twists the axles and decreased pressure on the plurality of gears 104 to prevent the tyres from slipping. This helps in eliminating the slippage between the at least two pressure plate 108 components as demonstrated in FIG. 5 (C).

In accordance with another advantageous embodiment of the present invention, the differential assembly 100 is designed to improve traction and handling by sending power to both wheels from the plurality of wheels of the axle, even if one wheel loses traction. The plurality of lubrication arrangements utilizes a specific type of limited slip differential (LSD) that uses plurality of discs 208 to provide the necessary resistance to send power to both of the wheels. In one embodiment, the plurality of discs 208 is a friction discs.

In accordance with another advantageous embodiment of the present invention, the present invention helps in flowing a sufficient amount of a lubricant to pass through the differential case 102, the plurality of discs 208 and the plurality of gears 104 by using the plurality of lubrication arrangements. Further, the present invention is easy to assemble, economical, and cost-effective.

In accordance with another advantageous embodiment of the present invention, the present invention improves the functionality and locking response of the differential assembly 100. The present invention is designed for maintaining zero tolerance by removing clucking noise generated from the differential assembly 100 when changing the plurality of gears 104 in a manual vehicle, and when setting the transmission to a reverse or a drive state in an automatic vehicle.

In accordance with another advantageous embodiment of the present invention, the present invention provides the plurality of gears 104 while minimizing any potential backlash or slack. It is well known that there may be no gear without some degree of backlash. However, the implementation of the at least one disc 208 from the plurality of discs 208 significantly reduces the amount of backlash and slack in the plurality of gears 104, bringing it to an absolute minimum, hence the present invention ensures the limited-slip differential mechanism may function optimally and reliably, even under extreme conditions.

Aspects of the present subject matter are described herein with reference to flowchart illustrations and/or block diagrams of methods and apparatus (systems) according to embodiments of the subject matter. It will be understood that each block of the flowchart illustrations and/or block diagrams, and combinations of blocks in the flowchart illustrations and/or block diagrams, can be implemented by computer readable program instructions.

While there has been shown, and described herein what are presently considered the preferred embodiments of the present disclosure, it will be apparent to those skilled in the art that various changes and modifications can be made therein without departing from the scope of the present disclosure as defined by the appended claims.

The flowchart and block diagrams in the Figures illustrate the architecture, functionality, and operation of possible embodiments of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative embodiments, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure. The accompanying claims and their equivalents are intended to cover such forms or modifications as would fall within the scope and spirit of the present disclosure.

### ELEMENT LIST

Differential Assembly 100
Differential Case 102
Plurality of gears 104
Elastic element 106
At least two pressure plate 108.
Outer circumferential surface 202
Inner circumferential surface 204
Plurality of apertures 206
Plurality of discs 208.
Plurality of mounting holes 302
At least seven oil holes 402
At least seven oil cut-outs 404.
At least seven oil grooves 406
Top surface 408
Outer periphery 410
Inner Periphery 412
Gap 502

We claim:

1. A differential assembly 100, comprising:
a differential case 102;
a plurality of gears 104 arranged inside the differential case 102; and
an elastic element 106 disposed between the differential case 102 and the plurality of gears 104, wherein the elastic element 106 comprises:
an inner circumferential surface 204 and an outer circumferential surface 202;
a plurality of mounting holes 302 formed at the outer circumferential surface 202 for fastening the clastic element 106 via a plurality of bolts;
a plurality of apertures 206 formed at the inner circumferential surface 204 for attaching the plurality of gears 104;
at least one disc 208 from a plurality of discs 208, positioned between each of the plurality of gears 104; and
a plurality of lubrication arrangements provided at a circumferential direction of the inner 204 and the outer circumferential surface 202 of the elastic element 106 for flowing a lubricant inside the differential case 102, the plurality of discs 208, and the plurality of gears 104.

2. The differential assembly 100 as claimed in claim 1, wherein the plurality of gears 104 is any one or a combination of a sun gear, a ring gear, a helical gear, a pinion gear, a half axle gear, a planetary bevel gear, a bevel gear, among others.

3. The differential assembly 100 as claimed in claim 1, wherein the plurality of lubrication arrangement includes a plurality of oil holes 402, a plurality of oil cut-outs 404, and a plurality of grooves 406.

4. The differential assembly 100 as claimed in claim 1, wherein a number of the plurality of oil holes 402, the plurality of oil cut-outs 404, and the plurality of grooves 406 depend upon a number of the plurality of gears 104.

5. The differential assembly 100 as claimed in claim 3, wherein a shape of the plurality of oil holes 402, the plurality of oil cut-outs 404, and the plurality of oil grooves 406 is a circular, a semi-circular, and a rectangular in nature respectively.

6. The differential assembly 100 as claimed in claim 3, wherein the plurality of oil holes 402 are provided at a top surface 408 of the elastic element 106.

7. The differential assembly 100 as claimed in claim 3, wherein the plurality of oil cut-outs 404 are provided at an outer periphery 410, and the plurality of oil grooves 406 are provided at an inner periphery 412 of an internal surface of the elastic element 106 which is further attached with the plurality of oil cut-outs 404.

8. The differential assembly 100 as claimed in claim 1, wherein the elastic element 106 is a disc washer.

9. The differential assembly 100 as claimed in claim 8, wherein the disc washer is a spring washer for providing a spring force and absorbing shock by providing an axial load that counters vibrations generated by the plurality of gears 104.

10. The differential assembly 100 as claimed in claim 1, wherein the elastic element 106 is made of any one of a stainless steel, a carbon steel, an alloy steel, and a rubber.

11. The differential assembly 100 as claimed in claim 1, wherein the elastic element 106 may also be arranged between the plurality of gears 104.

12. The differential assembly 100 as claimed in claim 1, wherein the differential assembly 100 has a limited-slip differential (LSD) mechanism for limiting the differential rotation between the plurality of gears 104 to distribute the rotational driving force to a driving wheel.

13. The differential assembly 100 as claimed in claim 11, wherein the limited-slip differential mechanisms are divided into multiple types, including but not limited to a mechanical friction type, and a rotational-speed-sensitive type.

14. The differential assembly 100 as claimed in claim 1, wherein further includes at least two pressure plates 108 are placed between the plurality of gears 104 for applying a spring pressure in an outward direction to keep the plurality of gears 104 engaged and limit the slack between the plurality of gears 104.

15. The differential assembly 100 as claimed in claim 1, wherein the plurality of gears 104 may vary from vehicle to vehicle depending on a size and a shape of the differential assembly 100.

16. The differential assembly 100 as claimed in claim 1, wherein a design of the plurality of discs 208 allows the placement of the number of plurality of gears 104 according to the specific application.

17. The differential assembly 100 as claimed in claim 4, wherein the number of plurality of gears 104 are anyone of at least four gears, at least five gears, at least six gears, at least seven gears, at least eight gears, at least nine gears, among others.
